(19) United States
(12) Patent Application Publication
(10) Pub. No.: US 2011/0248622 A1
(43) Pub. Date: Oct. 13, 2011

(54) ILLUMINATING DEVICE STRUCTURE

(76) Inventor: HSIANG-HUA WANG, Taipei City (TW)

(21) Appl. No.: 12/898,726

(22) Filed: Oct. 6, 2010

(30) Foreign Application Priority Data
Apr. 9, 2010 (TW) 099110978

(51) Int. Cl. H01J 1/62

(52) U.S. Cl. 313/483

(57) ABSTRACT

The illuminating device structure contains a heat-dissipating base, a circuit board on a top side of the heat-dissipating base, and at least a naked, high-powered LED die on the circuit board. A hollow cover is configured on the heat-dissipating base to cover the LED die. A phosphor layer is coated on an interior wall of the cover and a space is thereby reserved between the phosphor layer and the LED die. As such, the phosphor layer is protected against the heat and high temperature from the LED die by the space and therefore would enjoy an extended operation life.

### (a) TECHNICAL FIELD OF THE INVENTION

The present invention generally relates to illuminating devices, and more particular to a structure of illuminating devices where light emitting diode dies are integrated with phosphor powder in a non-contact manner.

### (b) DESCRIPTION OF THE PRIOR ART

The application of light emitting diodes (LEDs) in illuminating devices is gaining popularity and diversity A conventional illuminating device using LEDs is illustrated in FIG. 3 where a LED die, sealed in a phosphorous adhesive, is housed in an outer package. The phosphorous adhesive contains phosphor powder, adhesive, and activating agent, etc., and is in direct contact with the LED die. As the light from the LED die pass through the phosphorous adhesive, the light interacts with the phosphorous adhesive to produce white light or other colored light.

FIG. 4 provides another conventional illuminating device using LEDs. As illustrated, the phosphor powder is first coated on the LED die and phosphorous adhesive is then applied. FIG. 5 provides yet another conventional illuminating device using LEDs. As illustrated, the phosphor powder is positioned in an outmost layer of the phosphorous adhesive.

As the high-powered LED dies used in illuminating devices would produce a significant amount of heat, the adhesive, phosphor powder, and the activating agent are all directly exposed to this excessive heat for an extended period of time. As such, the phosphor powder often deteriorates from the high temperature of the LED dies, and the light from the LED dies suffer undesirable attenuation. In addition, the phosphorous adhesive is often embrittled and fractured. These are the common problems to the conventional LED-based illuminating devices.

To overcome these problems, phosphor powder and phosphorous adhesive robust to heat and high temperature are researched and developed, yet adding to the production cost of the illuminating devices.

On the other hand, it is also quite often that the phosphor powder is not uniformly distributed among the adhesive and would drift when the phosphorous adhesive is cured, resulting in undesirable color saturation and fidelity. The outer package and the LED die then have to be discarded as well, and the yield cannot be effectively improved.

### SUMMARY OF THE INVENTION

A main purpose of the present invention is to provide an illuminating device structure having a buffer space between the phosphor powder and the LED die so that the phosphor powder is not directly under the influence of the heat and high temperature from the LED die, and so that the production cost and operation life of the illuminating device could be effectively enhanced.

To achieve the foregoing purpose, the illuminating device structure contains a heat-dissipating base, a circuit board on a top side of the heat-dissipating base, and at least a naked, high-powered LED die on the circuit board.

A hollow cover is configured on the heat-dissipating base to cover the LED die. A phosphor layer is coated on an interior wall of the cover and a space is thereby reserved between the phosphor layer and the LED die. The phosphor layer absorbs the light from the LED die and produced high-powered white light.

As such, the phosphor layer is protected against the heat from the LED die by the space and therefore would enjoy an extended operation life. In addition, if the phosphor layer or the LED die is found to be defective, they could be replaced individually and separately, achieving a higher yield and a lower cost for the illuminating device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an illuminating device structure according to an embodiment of the present invention.

FIG. 2 is a schematic sectional diagram showing the illuminating device structure of FIG. 1.

FIG. 3 is a schematic diagram showing the structure of a first conventional illuminating device.

FIG. 4 is a schematic diagram showing the structure of a second conventional illuminating device.

FIG. 5 is a schematic diagram showing the structure of a third conventional illuminating device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

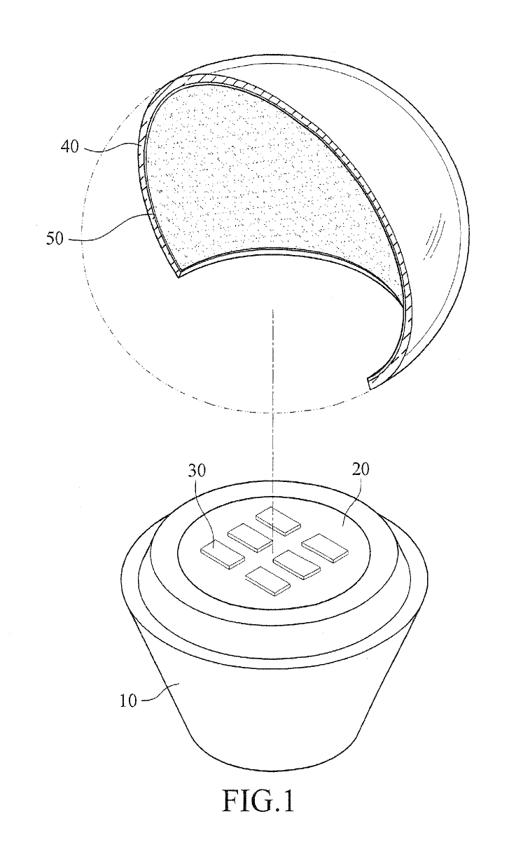

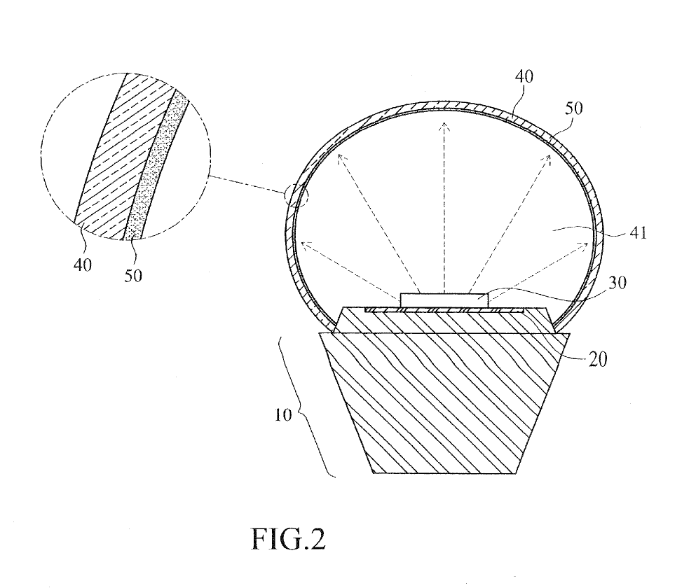

As shown in FIGS. 1 and 2, an illuminating device structure according to an embodiment of the present invention contains a heat-dissipating base 10, a circuit board 20 positioned on a top side of the heat-dissipating base 10, and at least a high-powered LED die 30 on the circuit board 20. The LED die 30 could be a naked die (i.e., without phosphor powder and lens) emitting blue-, red-, or green-colored light. Alternatively, the LED die 30 could be a naked die emitting ultra-violet (UV) light.

The heat-dissipating device 10 could be integrally formed, or it could be formed by adding a heat-dissipating module on a support base.

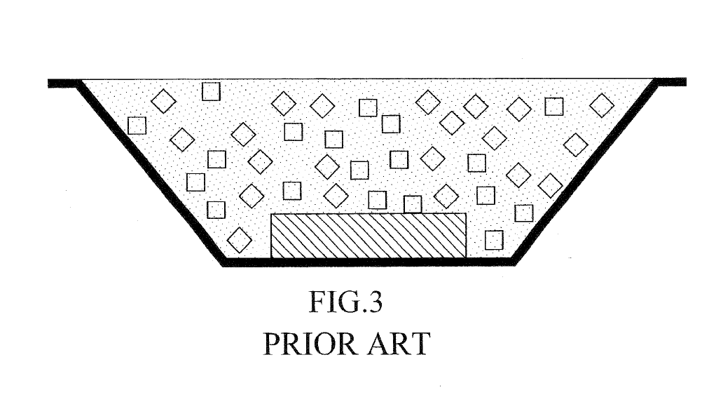

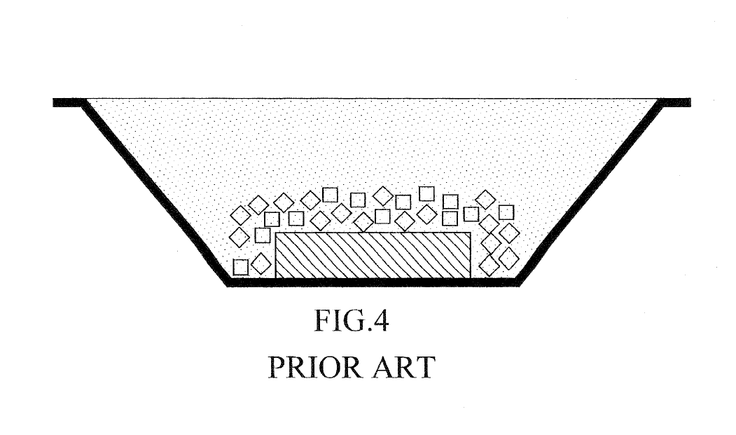

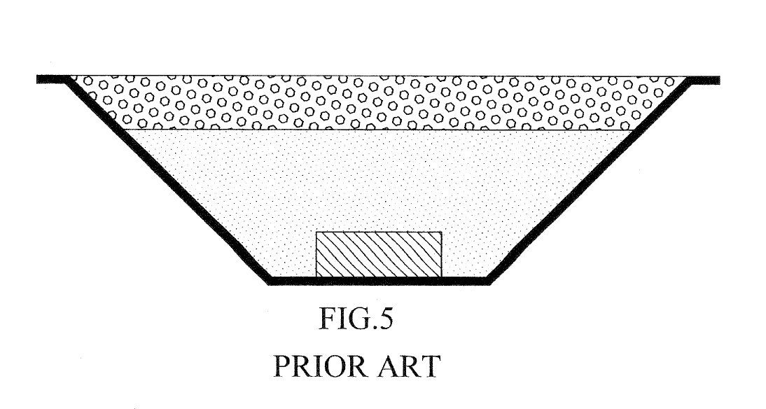

The illuminating device structure could further contain a hollow cover 40 configured on the heat-dissipating base 10 to house the LED die 30. The cover 40 could be shaped in various bulb shapes. A phosphor layer 50 is uniformly coated on an interior wall of the cover 40 and an ample space 41 is reserved between the phosphor layer 50 and the LED die 30 so that the phosphor layer 50 is not in direct contact with the heat produced by the LED die 30. Compared to the conventional illuminating devices of FIGS. 3, 4, and 5, it should be obvious that their ways of positioning the phosphor powder are distinctly different.

The phosphor layer 50 is configured in accordance with the LED die 30. For example, if the LED die 30 emits blue light, the phosphor layer 50 contains yellow phosphor powder so that blue light interacts with the yellow phosphor to produce white light. Similarly, if the LED die 30 emits green, red, or UV light, the phosphor layer 50 contains corresponding phosphor powder. The correspondence and interaction between the LED die 30 and the phosphor layer 50 are well known in the prior art and are not the subject matter of the present invention.

As shown in FIGS. 1 and 2, the light is uniformly radiated from the LED die 30 through the space 41, which functions as a buffer so that the phosphor layer 50 is not directly exposed to heat and temperature of the LED die 30. As such, the illuminating device would enjoy a significantly longer operation life.

The space 41 inside the cover 40 could be vacuumed or filled with air or an inert gas.

The cover 40, in additional to the bulb (spherical) shape, could have a semi-spherical, oval, or tubular shape (similar to a fluorescent lamp tube).

Due to the above described structure, the phosphor layer 50 is positioned at a distance from the LED die 30 and the phosphor layer 50 could be formed using less expensive materials that are not so robust to the high temperature. The production cost of the illuminating device therefore could be effectively reduced.

Additionally, if the LED die 30 or the phosphor layer 50 has defects, they could be replaced individually, achieving a superior yield and a further lower cost for the illuminating device.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An illuminating device structure, comprising:
a heat-dissipating base;
a circuit board positioned on a top side of said heat-dissipating base;
at least a high-powered LED die on said circuit board, said LED die being a naked die;
a hollow cover covering said top side of said heat-dissipating device and housing said LED chip; and
a phosphor layer coated on an interior wall of said cover;
wherein said phosphor layer absorbs light from said LED die and in turn produce white light; and a space is formed between said phosphor layer and said LED die.

2. The illuminating device structure according to claim 1, wherein said space is a vacuum.

3. The illuminating device structure according to claim 1, wherein said space is filled with a gas.

4. The illuminating device structure according to claim 1, wherein said cover has one of a spherical shape, a semi-spherical shape, and an oval shape.

5. The illuminating device structure according to claim 1, wherein said cover is shaped as a tube.
